(19) United States
(12) Patent Application Publication
(10) Pub. No.: US 2022/0147845 A1
(43) Pub. Date: May 12, 2022

(54) GENERATION OF RECOMMENDATION REASON

(71) Applicant: HANHAI INFORMATION TECHNOLOGY (SHANGHAI) CO., LTD., Shanghai (CN)

(72) Inventors: Rao FU, Shanghai (CN); Tian LAN, Shanghai (CN); Yuanyuan LU, Shanghai (CN); Peixu HOU, Shanghai (CN); Gong ZHANG, Shanghai (CN); Zhongyuan WANG, Shanghai (CN); Jingang WANG, Shanghai (CN); Fuzheng ZHANG, Shanghai (US)

(21) Appl. No.: 17/524,899

(22) Filed: Nov. 12, 2021

Related U.S. Application Data
(63) Continuation of application No. PCT/CN2020/095896, filed on Jun. 12, 2020.

(30) Foreign Application Priority Data
Jul. 8, 2019 (CN) 201910610508.6

(51) Int. Cl. G06N 5/04; G06N 5/02

(52) U.S. Cl. CPC G06N 5/04; G06N 5/022

(57) ABSTRACT

A recommendation reason generation method is disclosed in the present disclosure, including: obtaining, according to search data of a target user, at least one recalled result for the search data; and obtaining a recommendation reason of each recalled result by using a preset intelligent question answering model according to the search data, the at least one recalled result, and a target user profile of the target user. The intelligent question answering model is a first machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object.

### CROSS-REFERENCE TO RELATED APPLICATIONS

This application claims priority to Chinese Patent Application No. 201910610508.6, entitled “GENERATION OF RECOMMENDATION REASON” filed with the China National Intellectual Property Administration on Jul. 8, 2019, which is incorporated herein by reference in its entirety.

### TECHNICAL FIELD

The present disclosure relates to the field of computer technologies, and in particular, to a recommendation reason generation method and apparatus, an electronic device, and a readable storage medium.

### BACKGROUND

With the development of artificial intelligence (AI) technologies, related applications have increasingly important commercial value and social influence. How to resolve trust mechanisms in a decision-making process is a key factor to improve the further development of the AI. For example, for a search system, an assessment body is a user the system facing, and the user is greatly subjective. Therefore, the interpretability of results may directly affect an effect of the search system, and affect a trust degree and acceptance of the user for the system. In recent years, an interpretable search system has attracted more attention. A commodity or content is displayed to the user together with a recommendation reason. In this case, the transparency of the system is improved, and the trust degree and acceptance of the user for a platform are also enhanced.

Currently, there are mainly four recommendation reason generation methods in the industry: manual operation: an operator or specialist writes suitable text content for each merchant; rule template: an expert sets a plurality of templates, and splices the templates into suitable content; comment data extraction: extract some comments for a merchant written by users, to serve as recommendation reasons; and content generation: train a generation model by using a natural language processing (NPL) technology, to cause the model to generate suitable texts.

However, the four current mainstream recommendation reason generation methods all have some defects and limitations. In the method of manual operation, manually written sentences have high quality and diversified content, but have high costs, a limited quantity, and slowly updating, and cannot generate personalized content. In the method of rule template, compared with the manual operation, templates may reduce some costs to some extent, but the content is monotonous, coverage of available dimensions is limited, lack of universality, and also cannot meet personalized requirements. In the method of comment data extraction, the method strictly relies on the supply of the comment data, which has limitations to some extent.

In the method of content generation, good samples are lacked in a scenario of recommending reasons, and the method cannot generate personalized content for a single merchant. In view of this, the existing recommendation reason generation methods have technical problems such as high costs and insufficient personalization.

### SUMMARY

The present disclosure provides a recommendation reason generation method, an electronic device, and a readable storage medium, to resolve some or all of the foregoing problems in a recommendation reason generation process in the related art.

According to a first aspect of the present disclosure, a recommendation reason generation method is provided, including:

obtaining, according to search data of a target user, at least one recalled result for the search data; and

obtaining a recommendation reason of each recalled result by using a preset intelligent question answering model according to the search data, the at least one recalled result, and a target user profile of the target user, where

the intelligent question answering model is a machine learning model obtained through training according to at least one sample question answering data combination, and the sample question answering data combination including: a sample user profile and historical comment data of at least one sample user, a recommendation object corresponding to the historical comment data, and historical search data of the sample user for the recommendation object.

According to a second aspect of the present disclosure, a recommendation reason generation apparatus is provided, including:

a recalled result obtaining module, configured to obtain, according to search data of a target user, at least one recalled result for the search data; and

a recommendation reason generation module, configured to obtain a recommendation reason of each recalled result by using a preset intelligent question answering model according to the search data, the at least one recalled result, and a target user profile of the target user, where

the intelligent question answering model is a machine learning model obtained through training according to at least one sample question answering data combination, and the sample question answering data combination including: a sample user profile and historical comment data of at least one sample user, a recommendation object corresponding to the historical comment data, and historical search data of the sample user for the recommendation object.

According to a third aspect of the present disclosure, an electronic device is provided, including:

a memory, a processor, and a computer program stored on the memory and executable on the processor, when executing the program, the processor performing the foregoing recommendation reason generation method.

According to a fourth aspect of the present disclosure, a readable storage medium is provided, instructions in the storage medium, when executed by a processor of an electronic device, causing the electronic device to perform the foregoing recommendation reason generation method.

According to the recommendation reason generation method of the present disclosure, according to search data of a target user, at least one recalled result for the search data may be obtained, and a recommendation reason of each recalled result may be obtained by using a preset intelligent question answering model according to the search data, the at least one recalled result, and a target user profile of the target user. The intelligent question answering model is a machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object. Therefore, technical problems of high costs and insufficient personalization are resolved, and beneficial effects of improving the personalization of the recommendation reason while reducing the costs of generating the recommendation reason are achieved.

The foregoing description is merely an overview of the technical solutions of the present disclosure. To understand the present disclosure more clearly, implementation can be performed according to content of the specification. Moreover, to make the foregoing and other objectives, features, and advantages of the present disclosure more comprehensible, specific implementations of the present disclosure are particularly listed below.

### BRIEF DESCRIPTION OF THE DRAWINGS

To describe the technical solutions in the embodiments of the present disclosure or in the related art more clearly, accompanying drawings required for describing the embodiments or the related art are briefly described below. Apparently, the accompanying drawings in the following description show some embodiments of the present disclosure, and a person of ordinary skill in the art may still derive other accompanying drawings according to these accompanying drawings without creative efforts.

FIG. 1 is a first flowchart of steps of a recommendation reason generation method according to an embodiment of the present disclosure.

FIG. 2A is a first schematic diagram of displaying a list page of a recalled result according to an embodiment of the present disclosure.

FIG. 2B is a second schematic diagram of displaying a list page of a recalled result according to an embodiment of the present disclosure.

FIG. 2C is a third schematic diagram of displaying a list page of a recalled result according to an embodiment of the present disclosure.

FIG. 3 is a second flowchart of steps of a recommendation reason generation method according to an embodiment of the present disclosure.

FIG. 4 is a schematic diagram of an intelligent question answering model according to an embodiment of the present disclosure.

FIG. 5 is a schematic structural diagram of a content gate according to an embodiment of the present disclosure.

FIG. 6 is a first schematic structural diagram of a recommendation reason generation apparatus according to an embodiment of the present disclosure.

FIG. 7 is a second schematic structural diagram of a recommendation reason generation apparatus according to an embodiment of the present disclosure.

FIG. 8 schematically shows a block diagram of an electronic device for performing a method according to the present disclosure.

FIG. 9 schematically shows a storage unit for maintaining or carrying program code for implementing a method according to the present disclosure.

### DETAILED DESCRIPTION OF THE EMBODIMENTS

To make the objectives, technical solutions, and advantages of the embodiments of the present disclosure clearer, the technical solutions in the embodiments of the present disclosure are clearly and completely described with reference to the accompanying drawings in the embodiments of the present disclosure. Apparently, the described embodiments are merely some embodiments of the present disclosure rather than all of the embodiments. All other embodiments obtained by a person of ordinary skill in the art based on the embodiments of the present disclosure without creative efforts shall fall within the protection scope of the present disclosure.

### Embodiment 1

A recommendation reason generation method provided in the embodiments of the present disclosure is described in detail.

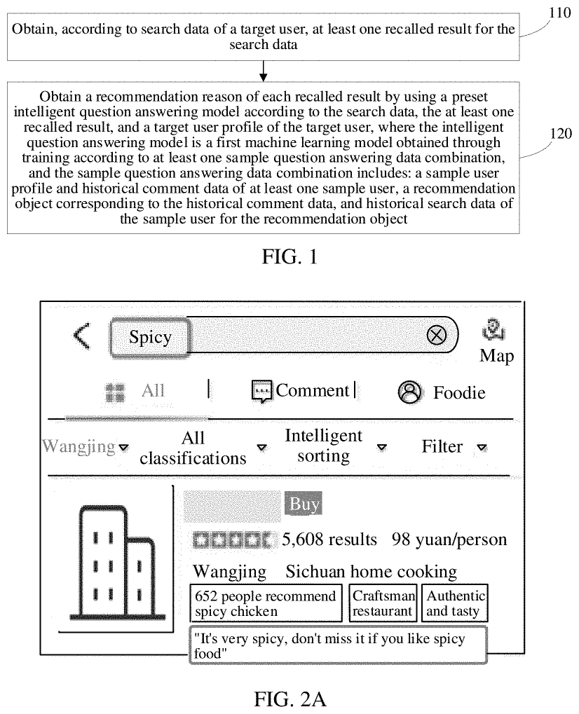

FIG. 1 is a flowchart of steps of a recommendation reason generation method according to an embodiment of the present disclosure.

Step 110. Obtain, according to search data of a target user, at least one recalled result for the search data.

On comment, search, and other network platforms, there may be massive alternative objects for each user to comment, browse, consume, and the like. However, different users have different requirements, or even the requirements of the same user may change at different moments. Therefore, the user needs to enter current search data thereof, to preliminarily select a target object meeting current requirements from the massive alternative objects. In this case, the obtained target object may be understood as a recalled result for the current search data of the target user.

In the embodiment of the present disclosure, at least one recalled result for the search data of the target user may be obtained by using any available method. This is not limited in the embodiment of the present disclosure. For example, after the search data of the target user is obtained, a matching degree between each alternative object and the search data may be obtained by using any available method, and the alternative object whose matching degree exceeds a preset matching threshold is used as the recalled result.

The search data may include, but is not limited to, a search keyword, a search time, a search location, a search scenario, or the like.

Step 120. Obtain a recommendation reason of each recalled result by using a preset intelligent question answering model according to the search data, the at least one recalled result, and a target user profile of the target user, where the intelligent question answering model is a first machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object.

In scenarios such as comment and search, the recommendation reason may mainly include the following effects:

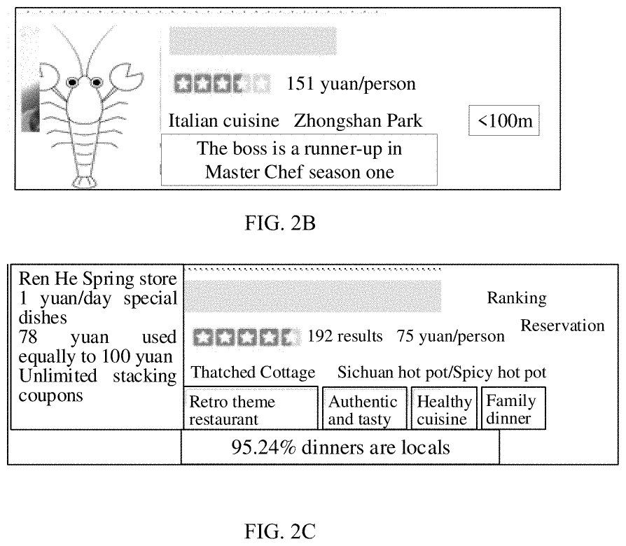

1. Recall explanation: explain search results to the user. As shown in FIG. 2A, when a keyword “spicy” is searched, the recalled result displayed on a list page cannot indicate a correlation between the recalled result and the search word “spicy”. In this case, a related information point “It's very spicy, don't miss it if you like spicy food” displayed according to the recommendation reason may have an effect of explaining the recall.

2. Highlight recommendation: introduce characteristics of each recalled result. The each recalled result displayed on the same list page usually cannot reflect respective characteristics and differences. In this case, the recommendation reason may show the highlights of the each recalled result to assist the user in making decisions. As shown in FIG. 2B, the recommendation reason “The boss is a runner-up in Master Chef season one” may show the highlights of the chef of the corresponding recalled result.

3. Scenario-based carry: generate content according to search scenarios of the user. A search scenario of the user greatly affects requirements of the user. For example, in a scenario of traveling outside, the user usually wants to experience local characteristics. In this case, it is more reasonable for the recommendation reason to show locals' favorite restaurants, for example, the recommendation reason “95.24% of diners are locals” shown in FIG. 2C.

4. Reflecting personalization: generate customized and diversified recommendation reason content according to user profiles. The recommendation reason for each recalled result is not unique. A recommendation reason that best fits a current user is shown according to different user preferences and historical behavior data, to meet requirements of the user to the greatest extent.

In the solution for generating a recommendation reason based on an intelligent question answering model provided in this application, the recommendation reason may be dynamically generated in real time, a “question” of the target user may be intelligently understood according to various dimensions of information including, but not limited to, the target user profile of the target user, the search data such as a search keyword, a search scenario, and a search time, and automatic recommendation reason writing of a corresponding topic is completed for the current recalled results.

The reason for modeling an intelligent question answering model is that the primary objective of the recommendation reason is to meet the requirements of the user. When the target user searches for one piece of search data in a search scenario, the recommendation reason needs to be capable of responding to the requirements of the target user. Based on this, the requirements of the user (including search data such as a preference, a search keyword, and a search scenario, and at least one recalled result corresponding to the search data) may be understood as a “question” raised by the target user, and the recommendation reason of each recalled result may be fed back to the target user as an “answer”.

Therefore, in the embodiments of the present disclosure, a recommendation reason of each recalled result may be obtained by using a preset intelligent question answering model according to the search data of the target user, the at least one recalled result for the corresponding search data, and the target user profile of the target user. The intelligent question answering model is a first machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object.

The search data may include, but is not limited to, at least one of a search scenario, a search keyword, and a search time, and the historical search data may be understood as search data before a current moment. The target user profile is a user profile of the target user, and the user profile is a labeled user model abstracted according to information such as social attributes, living habits, and consumption behavior of the user. A core work of constructing the user profile is to apply a “label” onto the user, and the label is a highly refined feature identifier obtained by analyzing user information. The user profile may include, but is not limited to, a user name, a user gender, a user age, a user profession, a user hobby, or the like.

In an actual application, behavior data of the user may reflect requirements of the user to some extent. For example, there is a certain correlation between comment content of the user, and content and requirement points on which the user focuses. In other words, the user visits a search platform when being in a search scenario with a search requirement, and comments written by the user after clicking or browsing and finally generating consumption behavior may reflect the requirement points on which the user focuses to some extent. A sample question answering data combination corresponding to a sample user may be constructed by backtracking historical behavior data such as historical comment data and historical search data of the sample user, and a recommendation object corresponding to the historical behavior data, and an intelligent question answering model may be further obtained through training according to at least one sample question answering data combination.

The intelligent question answering model may be any available machine learning model, and specifically, the intelligent question answering model may be preset according to requirements. This is not limited in the embodiments of the present disclosure.

During training of intelligent question answering model, the historical comment data corresponding to the sample user, the commented recommendation object corresponding to the historical comment data, the historical search data of the sample user for the corresponding recommendation object, and a user profile of the sample user, that is, a sample user profile may be obtained from the historical behavior data of the sample user, and the intelligent question answering model is further trained according to the corresponding historical comment data, the historical search data, the sample user profile, and the corresponding recommendation object.

The historical search data of the sample user for the corresponding recommendation object may include historical search data of the sample user for the recommendation object within a preset historical time period, or may include historical search data corresponding to the historical comment data, or the like. Specific historical search data may be preset according to requirements. This is not limited in the embodiments of the present disclosure.

For example, for a sample user A, it is assumed that historical behavior data of the sample user A includes historical comment data C for a recommendation object B, the sample user A has performed search behavior for N times within the preset historical time period, and recommendation objects of M times of search behavior include the recommendation object B, that is, the sample user A has performed M times of search behavior for the recommendation object B within the preset historical time period, and historical search data corresponding to each search behavior is sequentially D1, D2, . . . Dm.

It is assumed that the sample user A obtains the recommendation object B after inputting the historical search data D1, further generates consumption behavior for the recommendation object B, and then comments the recommendation object B after the consumption behavior, in addition, current comment data is the foregoing historical comment data C. In this case, corresponding to the historical comment data C, the historical search data of the sample user A for the recommendation object B may include the foregoing historical search data D1. Certainly, corresponding to the historical comment data C, the historical search data of the sample user A for the recommendation object B may include the foregoing historical search data D1, D2, . . . , Dm.

After the intelligent question answering model is obtained through training, a recommendation reason for each recalled result may be obtained by using the preset intelligent question answering model according to the search data of the target user, the at least one recalled result for the search data, and the target user profile of the target user.

After the recommendation reason of each recalled result are obtained, the recommendation reason and the corresponding at least one recalled result may be returned to the target user. In addition, the recommendation reason of each recalled result may be displayed simultaneously when the at least one recalled result is displayed to the target user, to assist the target user in selecting a recalled result meeting the requirements of the target user. A specific display manner may be preset according to requirements. This is not limited in the embodiments of the present disclosure.

In the embodiments of the present disclosure, according to search data of a target user, at least one recalled result for the search data may be obtained according to search data, and a recommendation reason of each recalled result may be obtained by using a preset intelligent question answering model according to the search data, the at least one recalled result, and a target user profile of the target user. The intelligent question answering model is a first machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object. Therefore, beneficial effects of improving the personalization of the recommendation reason while reducing the costs of generating the recommendation reason are achieved.

### Embodiment 2

A recommendation reason generation method provided in the embodiments of the present disclosure is described in detail.

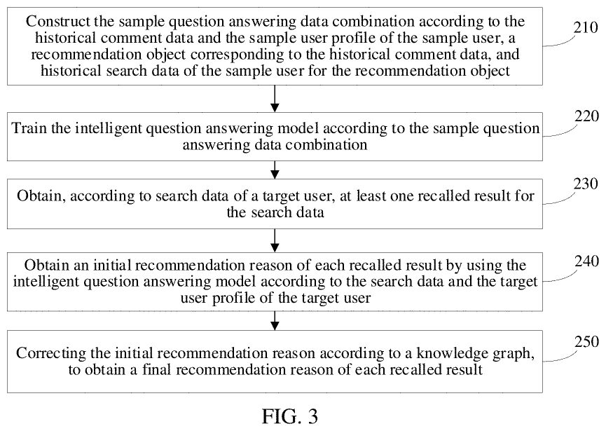

FIG. 3 is a flowchart of steps of a recommendation reason generation method according to an embodiment of the present disclosure.

Step 210. Construct the sample question answering data combination according to the historical comment data and the sample user profile of the sample user, the recommendation object corresponding to the historical comment data, and the historical search data of the sample user for the recommendation object.

To train the intelligent question answering model, a sample question answering data combination for training the intelligent question answering model needs to be constructed. As described above, during searching, the user needs to input search data meeting the requirements of the user, and a search platform may return a corresponding recommendation object to the corresponding user according to a search request of the user. Historical behavior data includes the historical search data and the historical comment data of the corresponding user. In addition, the sample user profile may represent user features of the corresponding sample user. Therefore, in the embodiments of the present disclosure, the sample question answering data combination may be constructed according to the historical comment data and the sample user profile of the selected sample user, the recommendation object corresponding to the historical comment data, and the historical search data of the corresponding sample user for the corresponding recommendation object.

Optionally, in the embodiments of the present disclosure, step 210 may further include:

Substep 211. Obtain a commented target recommendation object of the sample user according to historical behavior data of the sample user and a recommendation object corresponding to the historical behavior data.

The historical behavior data of the user may include all historical behavior data of the sample user. However, in the embodiments of the present disclosure, to train the intelligent question answering model, it needs to be ensured that each “question” in the sample question answering data combination has a corresponding “answer”. The “answer” may include historical comment data of the sample user for a recommendation object, and the “question” may include a corresponding recommendation object, and historical search data of the corresponding sample user for the corresponding recommendation object. In view of this, the “question” and “answer” corresponding to the same sample question answering data combination correspond to the same recommendation object.

In an actual application, for each recommendation object returned according to a search behavior of the user, the corresponding user may not necessarily comment at least one of the each recommendation object. Generally, if the user comments an object, the object is generally one of the each recommendation object returned according to the search behavior of the user.

In view of this, to obtain the sample question answering data combination corresponding to the sample user, the recommendation object corresponding to the sample question answering data combination may be first obtained, and then corresponding “question” and “answer” are further obtained from the historical behavior data of the user according to the recommendation object. Therefore, in the embodiments of the present disclosure, a commented target recommendation object of the sample user may be first obtained based on the historical behavior data and the recommendation object of the sample user.

For example, by backtracking historical behavior data of a sample user a1, it is found that at 19:00 on Valentine's Day in a past year, the sample user a1 searched for a keyword “food”, performed consumption behavior on a returned recommendation object b1, commented the recommendation object b1 after consumption with comment content “This is a petty bourgeoisie restaurant suitable for couples to date”, and a user profile of the sample user a1 includes: petty bourgeoisie. In this case, a commented target recommendation object b1 of the sample user a1 may be obtained.

Substep 212. Obtain a sample recommendation reason of the sample user for the target recommendation object according to historical comment data of the sample user for the target recommendation object.

After the commented target recommendation object of the sample user is determined, the sample recommendation reason of the corresponding sample user for the corresponding target recommendation object may be obtained according to the historical comment data for the corresponding target recommendation object in the historical behavior data of the sample user.

For example, for the foregoing sample user a1 and the target recommendation object b1, the foregoing comment content “This is a petty bourgeoisie restaurant suitable for couples to date” may be obtained as the sample recommendation reason of the sample user a1 for the target recommendation object b1.

Substep 213. Obtain sample question data of the sample user for the target recommendation object according to the sample user profile of the sample user, the target recommendation object, and historical search data corresponding to the historical comment data.

After the target recommendation object corresponding to the sample question answering data combination is determined, the sample question data of the corresponding sample user for the corresponding target recommendation object may be obtained according to the sample user profile of the sample user and the historical search data corresponding to the historical comment data in the historical behavior data of the sample user. The sample question data may include, but is not limited to, the sample user profile of the sample user, the historical search data corresponding to the historical comment data such as a historical search time, a historical search location, a historical search scenario, and a historical search keyword, the user profile of the sample user, that is, the sample user profile, and the corresponding target recommendation object.

As described above, the historical search data for the target recommendation object in the historical behavior data may specifically include: all historical search data of the corresponding sample user for the target recommendation object in the historical behavior data, or historical search data within a preset historical time period; or may merely include the historical search data corresponding to the historical comment data.

For example, for the foregoing sample user a1 and the recommendation object b1, it is assumed that in addition to the foregoing behavior data, the historical behavior data of the sample user a1 further includes search behavior of the sample user a1 for a keyword “Western food” at 18:00 on Dragon Boat Festival in the same year, and a returned result of this search behavior also includes the recommendation object b1. However, for the returned result of this search behavior, the sample user a1 did not consume and comment the recommendation object b1. Based on the foregoing historical behavior data of the sample user a1, the commented target recommendation object b1 of the sample user a1 may still be obtained.

If it is set in this case that the historical search data for the target recommendation object in the historical behavior data may include all historical search data of the corresponding sample user for the target recommendation object in the historical behavior data, the obtained historical search data of the sample user a1 for the target recommendation object b1 may include the following content:

historical search time: 19:00, historical search scenario: Valentine's Day, historical search keyword: food; and

historical search time: 18:00, historical search scenario: Dragon Boat Festival, historical search keyword: Western food.

If it is set in this case that the historical search data for the target recommendation object in the historical behavior data merely includes the historical search data corresponding to the historical comment data, the obtained historical search data of the sample user a1 for the target recommendation object b1 may include the following content:

historical search time: 19:00, historical search scenario: Valentine's Day, historical search keyword: food.

In an actual application, requirements of the same user at different times may not be consistent, and inputted search data may also be different. However, the same recommendation object may be returned for search data that is not exactly the same. The user may consume and comment a returned recommendation object according to requirements during a search, but may not consume and comment a corresponding recommendation object during another search. If the user chooses to consume and comment a recommendation object, it indicates that the recommendation object in this case may better meet the requirements of the user during a current search. In this case, comment data of the corresponding user after consumption has a higher matching degree with current search data of the corresponding user and the corresponding recommendation object.

Therefore, in the embodiments of the present disclosure, the historical search data corresponding to the historical comment data, the sample user profile of the corresponding sample user, and the corresponding target recommendation object may be preferably obtained according to the historical comment data of the sample user for the target recommendation object, to obtain the sample question data of the sample user for the target recommendation object.

For example, for the foregoing sample user a1 and the target recommendation object b1, the obtaining the historical search data of the sample user a1 for the target recommendation object b1 includes the following content:

historical search time: 19:00, historical search scenario: Valentine's Day, historical search keyword: food.

In the embodiments of the present disclosure, substep 213 may be performed before substep 212, or may be performed simultaneously with substep 212. This is not limited in the embodiments of the present disclosure.

Substep 214. Construct the sample question answering data combination by using the sample question data as an input question of the intelligent question answering model, and using the sample recommendation reason as an output answer of the intelligent question answering model.

After the sample question data and sample recommendation reason of the sample user for a commented recommendation object are obtained, the sample question answering data combination may be constructed by using the sample question data as the input question of the intelligent question answering model, and using the sample recommendation reason as the output answer of the intelligent question answering model.

During training of the intelligent question answering model, the sample question data in the sample question answering data combination may be used as a model input of the intelligent question answering model, and the sample recommendation reason in the corresponding sample question answering data combination may be used as a model output of the intelligent question answering model, to train parameters in the intelligent question answering model.

Step 220. Train the intelligent question answering model according to the sample question answering data combination.

Step 230. Obtain, according to search data of a target user, at least one recalled result for the search data.

Step 240. Obtain an initial recommendation reason of each recalled result by using the intelligent question answering model according to the search data and a target user profile of the target user.

Step 250. Correct the initial recommendation reason according to a knowledge graph, to obtain a final recommendation reason of each recalled result.

The intelligent question answering model may generate different recommendation reasons according to different inputted information points, for example:

Input: the recalled result is a merchant A, a user who likes trendy, search for Western food⇒Output: all trendy people come to this Western food restaurant for dinner; and

Input: the recalled result is a merchant A, Valentine's Day, search at night⇒Output: a good place for Valentine's Day dinner.

However, the recommendation reason outputted based on the trained intelligent question answering model may not meet general expression principles and result in ungrammatical sentences, or may not meet a real-time state of a corresponding recalled result. Therefore, in the embodiments of the present disclosure, to further improve the reliability of the generated recommendation reason, it may be set that a recommendation reason of each recalled result may be obtained as an initial recommendation reason by using the intelligent question answering model based on the search data and the target user profile of the target user, and the initial recommendation reason is corrected according to the knowledge graph, to obtain the final recommendation reason of each recalled result.

The knowledge graph is a modern theory that combines the theories and methods of disciplines such as applied mathematics, graphics, information visualization technology, and information science with methods such as metrology citation analysis and co-occurrence analysis, and uses visualized graph to vividly display the core structure, development history, frontier fields, and overall knowledge architecture of the disciplines to achieve multidisciplinary integration. The knowledge graph in the embodiments of the present disclosure may include, but is not limited to, real-time states of different recalled results, grammar, syntax, names of different objects corresponding to different recalled results, dependency relationships among various objects, and the like. There are a large amount of information and relationship chains stored in the knowledge graph, and some unreasonable content may be found according to such relationships and knowledge.

For example, as for a recalled result of XXXX hotel, an initial recommendation reason obtained by using the intelligent question answering model includes content “It's a comfortable and cost-effective five-star hotel!”. However, according to the knowledge graph, it may be found that the XXXX hotel is not a five-star hotel, but a four-star hotel. Therefore, the initial recommendation reason may be corrected, to obtain a final recommendation reason of the recalled result as “It's a comfortable and cost-effective four-star hotel!”.

As for a recalled result of XX restaurant, an initial recommendation reason obtained by using the intelligent question answering model includes content “Black Truffle Shrimp Dumpling is a signature dish of this restaurant”. Recently, the dish has been removed off its shelves, and such an information point is not to be used for guiding users.

As for a recalled result of XXXX plaza, an initial recommendation reason obtained by using the intelligent question answering model includes content “a relatively small mall”. A sentimental tendency of the initial recommendation reason is relatively negative, and is not suitable for displaying.

As for a recalled result of a hotel c1, an initial recommendation reason obtained by using the intelligent question answering model includes content “A coffee shop environment of a hotel c2 is elegant”. Semantic space vectors of the hotels c1 and c2 are similar, and there is a deviation during model prediction, resulting in a semantic drift in the content of the recommendation reason. Therefore, the recommendation reason needs to be corrected. In this case, the content may be corrected after an operation of named entity recognition is performed on the sentence.

In the embodiments of the present disclosure, a correction manner for the initial recommendation reason may include adjusting some fields in the foregoing initial recommendation reason, or may include replacing all fields in the initial recommendation reason, or directly deleting the initial recommendation reason. A specific correction manner may be preset according to requirements. This is not limited in the embodiments of the present disclosure.

For example, the intelligent question answering model may output a plurality of recommendation reason copies and scores of the recommendation reason copies according to current input content, and select a recommendation reason copy having the highest score as the initial recommendation reason. If the current initial recommendation reason does not meet the knowledge graph, the current initial recommendation reason may be filtered out, and a recommendation reason copy having the highest score is repeatedly selected as the initial recommendation reason until a current final recommendation reason is obtained. If the current initial recommendation reason meets the knowledge graph, the initial recommendation reason is directly determined as the final recommendation reason without correction.

Optionally, in the embodiments of the present disclosure, step 250 may further include:

Substep 251. Perform preprocessing on the initial recommendation reason, the preprocessing including at least one of named entity recognition (NER), syntactic parsing, and dependency parsing.

Substep 252. Correct a preprocessed initial recommendation reason according to the knowledge graph, to obtain the final recommendation reason of each recalled result.

It can be learned from the foregoing content that, before the initial recommendation reason is corrected, a part of the initial recommendation reason that needs to be corrected needs to be detected. To determine the part that needs to be corrected more accurately, preprocessing may be first performed on the initial recommendation reason. The preprocessing may include, but is not limited to, at least one of named entity recognition (NER), syntactic parsing, and dependency parsing.

The NER is also referred to as “proper name recognition” which refers to recognizing entities having specific meanings in text, which mainly includes a personal name, a place name, an institution name, a proper noun, and the like. The syntactic parsing refers to parsing grammatical functions of words in a sentence, for example, in a sentence “I come late.”, “I” is a subject, “come” is a predicate, and “late” is a complement. The structure of dependency grammar has no non-terminal node. There is a direct dependency relationship between words to form a dependency pair, one of the words is a core word (which is also referred to as a governing word), and the other is a modifier (which is also referred to as a dependent word). The dependency parsing explains a syntactic structure thereof by parsing dependency relationships among elements in a linguistic unit, and considers a core verb in a sentence as a core element that governs other elements. However, the core verb is not governed by any other element, and all governed elements are subordinate to a governor in a specific relationship.

In the embodiments of the present disclosure, NER, syntactic parsing, and dependency parsing may be performed by using any available method. This is not limited in the embodiments of the present disclosure.

Further, the preprocessed initial recommendation reason may be corrected according to the knowledge graph, to obtain the final recommendation reason of each recalled result, thereby improving correction efficiency and accuracy of the recommendation reason.

Optionally, in the embodiments of the present disclosure, substep 252 may further include:

Substep 2521. Obtain a replaceable field in the preprocessed initial recommendation reason based on a preset classification model, where the classification model is a second machine learning model obtained through training based on the knowledge graph.

Substep 2522. Correct the replaceable field, to obtain the final recommendation reason of each recalled result.

In addition, in the embodiments of the present disclosure, to further improve the correction efficiency and accuracy, a classification model may be trained in advance according to the knowledge graph. The classification model may be any available machine learning model, and is not limited in the embodiments of the present disclosure. In this case, to distinguish from the foregoing first machine learning model corresponding to the intelligent question answering model, the classification model may be defined as a second machine learning model obtained through training based on the knowledge graph. However, the second machine learning model may be a machine learning model of the same type with the foregoing first machine learning model, or may be a machine learning model of a different type. This is not limited in the embodiments of the present disclosure.

Further, a replaceable field in the preprocessed initial recommendation reason may be obtained based on the preset classification model, and then the replaceable field is corrected, to obtain the final recommendation reason of each recalled result.

Optionally, in the embodiments of the present disclosure, the intelligent question answering model includes a seq2seq framework model combining an attention mechanism, the attention mechanism including a coverage attention mechanism, and a prediction manner of the intelligent question answering model includes a beam search manner. A decoding layer of the seq2seq framework determines, through a context gate and when an input of the decoding layer of a current decoding step is obtained, a weight of an output of a previous decoding step of the decoding layer for the input of the current decoding step.

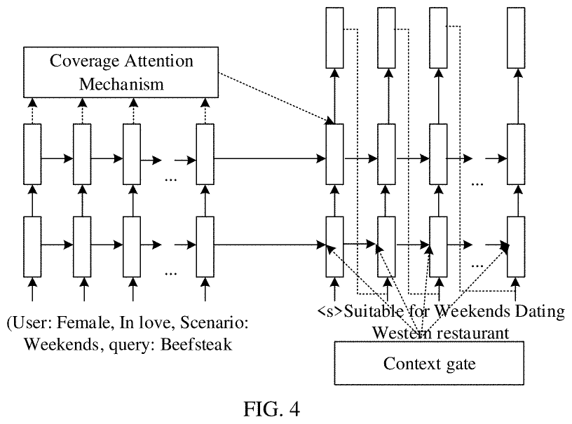

In an actual application, the recommendation reason may be understood as text information, and the search data may also be understood as text information. Therefore, when the intelligent question answering model is set, a seq2seq framework that is commonly used in the field of text generation may be selected combining an attention mechanism. For example, as shown in FIG. 4, the seq2seq framework includes three parts: an encoding layer, a decoding layer, and an intermediate state vector connecting the two layers. The encoding layer encodes, by learning an input, the input into a state vector S of a fixed size, and transmits the state vector S to the decoding layer, and then the decoding layer outputs by learning the state vector S.

For example, it is assumed that current input content of the intelligent question answering model includes the foregoing content that the recalled result is a merchant A, a user who likes trendy, and search for Western food. The encoding layer encodes, by learning the input, the input into a state vector S of a fixed size, and transmits the state vector S to the decoding layer. The decoding layer outputs by learning the state vector S, and the decoding layer may perform a plurality times of decoding on the state vector S, to learn and generate the final recommendation reason for output.

In this case, for each decoding step, an input in a current decoding step may include a weighted output in a previous decoding step. Therefore, a weight of the output in the previous decoding step for the input in the current decoding step needs to be determined. In the embodiments of the present disclosure, the decoding layer of the seq2seq framework may determine, through the context gate mechanism and when an input of the decoding layer in a current decoding step is obtained, a weight of an output of the decoding layer in a previous decoding step for the input in the current decoding step.

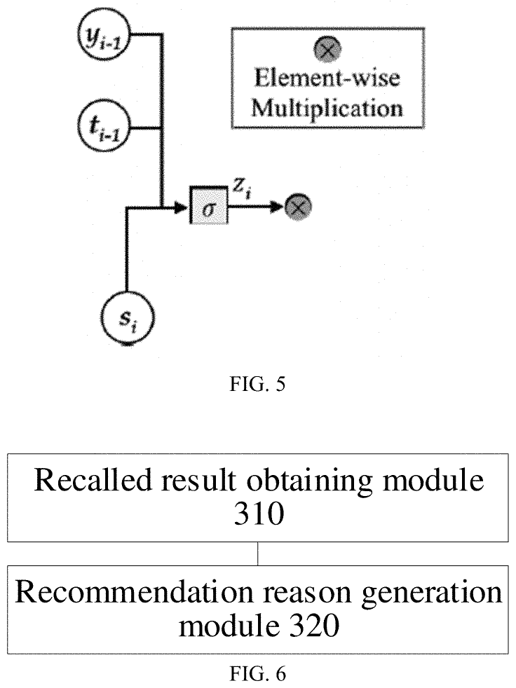

Formally, as shown in FIG. 5, the context gate is formed by a sigmoid neural network layer and an element-wise multiplication operation. The context gate may allocate an element weight for an input signal, and a calculation formula of the element weight may be zᵢ=σ(W_{z}e (yᵢ₋₁)+U_{z}tᵢ₋₁+C_{z}sᵢ).

i represents a decoding step sequence, σ(□) is a logistic sigmoid function, W_{z} ∈ R^{n×m}, U_{z} ∈ R^{n×n}, and C_{z} ∈ R^{n×n′} are weight matrices, and n, m, and n′ are respectively dimensions of word embedding, decoding state, and source representation. Dimensions of zᵢ and the input signal are the same. Therefore, each element in an input vector has a respective weight. In this case, the input vector may include an output vector in the previous decoding step.

In addition, as a model optimization point, in the embodiments of the present disclosure, a coverage attention mechanism is introduced based on the attention mechanism, memory information is additionally added to the original attention mechanism by using a coverage mechanism, to increase the cost of information reusing, so that the use coverage of all representation information during modeling is improved, and a problem of “over translation” of the model may be avoided. During optimization of other models, a beam search manner is used for prediction, to ensure the smoothness of a sentence to the greatest extent. The context gate may be further used in a decoding stage. The principle of the context gate is to determine a weight of an output of the decoding layer in a previous decoding stage for an input of a current decoding step when the input of the decoding layer in the current decoding step is obtained, thereby optimizing the information points and smoothness of the sentence.

In the embodiments of the present disclosure, the sample question answering data combination may be constructed according to the historical comment data and the sample user profile of the sample user, the recommendation object corresponding to the historical comment data, and the historical search data of the sample user for the recommendation object, and then the intelligent question answering model is trained according to the sample question answering data combination. In addition, a commented target recommendation object of the sample user is obtained according to historical behavior data of the sample user and a recommendation object corresponding to the historical behavior data; sample question data of the sample user for the target recommendation object is obtained according to the sample user profile of the sample user, the target recommendation object, and historical search data corresponding to the historical comment data; a sample recommendation reason of the sample user for the target recommendation object is obtained according to historical comment data of the sample user for the target recommendation object; and the sample question answering data combination is constructed by using the sample question data as an input question of the intelligent question answering model, and using the sample recommendation reason as an output answer of the intelligent question answering model. The sample question answering data combination is constructed according to the historical behavior data of the user, so that training data may be easily obtained, and personalized performance requirements may be further met.

In addition, in the embodiments of the present disclosure, an initial recommendation reason of each recalled result may be obtained by using the intelligent question answering model according to the search data and the target user profile of the target user, and the initial recommendation reason is corrected according to the knowledge graph, to obtain a final recommendation reason of each recalled result. Preprocessing is performed on the initial recommendation reason, the preprocessing including at least one of named entity recognition (NER), syntactic parsing, and dependency parsing; and a preprocessed initial recommendation reason is corrected according to the knowledge graph, to obtain the final recommendation reason of each recalled result. A replaceable field in the preprocessed initial recommendation reason may be obtained based on a preset classification model, and then the replaceable field is corrected, to obtain the final recommendation reason of each recalled result. The classification model is a second machine learning model obtained through training based on the knowledge graph. Therefore, the validity of the recommendation reason, and the correction efficiency and accuracy of the recommendation reason may be further improved.

In addition, in the embodiments of the present disclosure, the intelligent question answering model includes a seq2seq framework model combining an attention mechanism, and the attention mechanism includes a coverage attention mechanism, thereby avoiding a problem of “over translation” of the model. A prediction manner of the intelligent question answering model includes a beam search manner, to ensure the smoothness of a sentence to the greatest extent. A decoding layer of the seq2seq framework determines, through a context gate and when an input of the decoding layer in a current decoding step is obtained, a weight of an output of the decoding layer in a previous decoding step for the input in the current decoding step, thereby optimizing the information points and smoothness of the sentence.

For ease of description, the method embodiments are all described as a series of action combinations. However, a person skilled in the art should know that the embodiments of the present disclosure are not limited by the described action sequence because some steps may be performed in other sequences or simultaneously according to the embodiments of the present disclosure. In addition, a person skilled in the art also should understand that the embodiments described in this specification are all exemplary embodiments; and therefore, the actions involved are not necessarily mandatory in the embodiments of the present disclosure.

### Embodiment 3

A recommendation reason generation apparatus provided in the embodiments of the present disclosure is described in detail.

FIG. 6 is a schematic structural diagram of a recommendation reason generation apparatus according to an embodiment of the present disclosure.

A recalled result obtaining module 310 is configured to obtain, according to search data of a target user, at least one recalled result for the search data.

A recommendation reason generation module 320 is configured to obtain a recommendation reason of each recalled result by using a preset intelligent question answering model according to the search data, the at least one recalled result, and a target user profile of the target user. The intelligent question answering model is a machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object.

In the embodiments of the present disclosure, according to search data of a target user, at least one recalled result for the search data may be obtained, and a recommendation reason of each recalled result may be obtained by using a preset intelligent question answering model according to the search data, the at least one recalled result, and a target user profile of the target user. The intelligent question answering model is a first machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object. Therefore, beneficial effects of improving the personalization of the recommendation reason while reducing the costs of generating the recommendation reason are achieved.

### Embodiment 4

A recommendation reason generation apparatus provided in the embodiments of the present disclosure is described in detail.

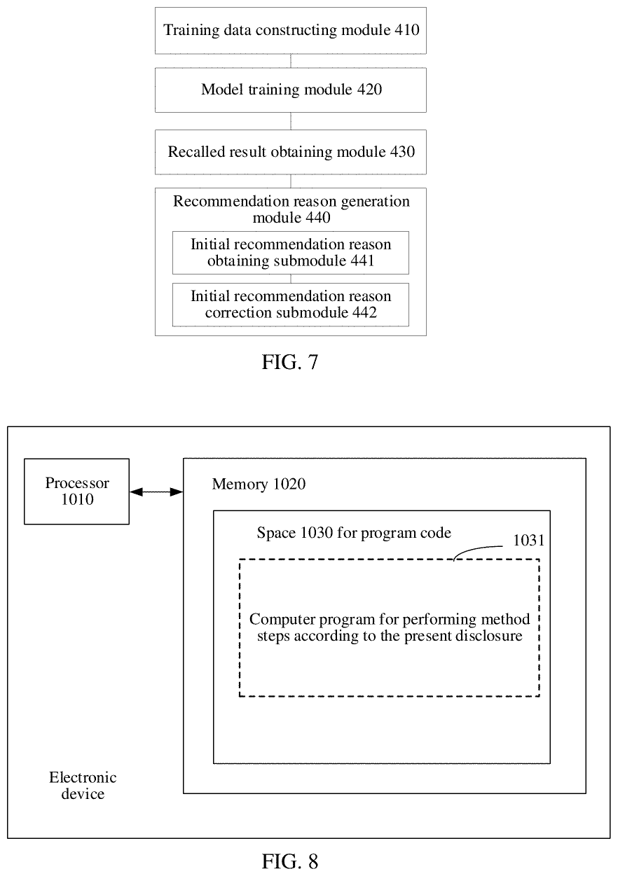

FIG. 7 is a schematic structural diagram of a recommendation reason generation apparatus according to an embodiment of the present disclosure.

A training data constructing module 410 is configured to construct the sample question answering data combination according to the historical comment data and the sample user profile of the sample user, the recommendation object corresponding to the historical comment data, and the historical search data of the sample user for the recommendation object.

Optionally, in the embodiments of the present disclosure, the training data constructing module 410 may further include:

a recommendation object obtaining submodule, configured to obtain a commented target recommendation object of the sample user according to historical behavior data of the sample user and a recommendation object corresponding to the historical behavior data;

a sample recommendation reason obtaining submodule, configured to obtain a sample recommendation reason of the sample user for the target recommendation object according to historical comment data of the sample user for the target recommendation object;

a sample question data obtaining submodule, configured to obtain sample question data of the sample user for the target recommendation object according to the sample user profile of the sample user, the target recommendation object, and historical search data corresponding to the historical comment data; and

a training data constructing submodule, configured to construct the sample question answering data combination by using the sample question data as an input question of the intelligent question answering model, and using the sample recommendation reason as an output answer of the intelligent question answering model.

A model training module 420 is configured to train the intelligent question answering model according to the sample question answering data combination.

A recalled result obtaining module 430 is configured to obtain, according to search data of a target user, at least one recalled result for the search data.

A recommendation reason generation module 440 is configured to obtain a recommendation reason of each recalled result by using a preset intelligent question answering model according to the search data, the at least one recalled result, and a target user profile of the target user, where the intelligent question answering model is a machine learning model obtained through training according to at least one sample question answering data combination, and the sample question answering data combination includes: a sample user profile and historical comment data of at least one sample user, a recommendation object corresponding to the historical comment data, and historical search data of the sample user for the recommendation object.

In the embodiments of the present disclosure, the recommendation reason generation module 440 may further include:

an initial recommendation reason obtaining submodule 441, configured to obtain an initial recommendation reason of each recalled result by using the intelligent question answering model according to the search data and the target user profile of the target user; and

an initial recommendation reason correction submodule 442, configured to correct the initial recommendation reason according to a knowledge graph, to obtain a final recommendation reason of each recalled result.

Optionally, in the embodiments of the present disclosure, the initial recommendation reason correction submodule 442 may further include:

a preprocessing unit, configured to perform preprocessing on the initial recommendation reason, the preprocessing including at least one of named entity recognition (NER), syntactic parsing, and dependency parsing; and

a correction unit, configured to correct a preprocessed initial recommendation reason according to the knowledge graph, to obtain the final recommendation reason of each recalled result.

Optionally, in the embodiments of the present disclosure, the correction unit may further include:

a replaceable field obtaining subunit, configured to obtain a replaceable field in the preprocessed initial recommendation reason based on a preset classification model, where the classification model is a second machine learning model obtained through training based on the knowledge graph; and

a replaceable field correction subunit, configured to correct the replaceable field, to obtain the final recommendation reason of each recalled result.

Optionally, in the embodiments of the present disclosure, the intelligent question answering model includes a seq2seq framework model combining an attention mechanism, the attention mechanism including a coverage attention mechanism, a prediction manner of the intelligent question answering model includes a beam search manner. A decoding layer of the seq2seq framework determines, through a context gate and when an input of the decoding layer in a current decoding step is obtained, a weight of an out of the decoding layer in a previous decoding step for the input in the current decoding step.

In the embodiments of the present disclosure, the sample question answering data combination may be constructed according to the historical comment data and the sample user profile of the sample user, the recommendation object corresponding to the historical comment data, and the historical search data of the sample user for the recommendation object, and then the intelligent question answering model is trained according to the sample question answering data combination. In addition, a commented target recommendation object of the sample user is obtained according to historical behavior data of the sample user and a recommendation object corresponding to the historical behavior data; sample question data of the sample user for the target recommendation object is obtained according to the sample user profile of the sample user, the target recommendation object, and historical search data corresponding to the historical comment data; a sample recommendation reason of the sample user for the target recommendation object is obtained according to historical comment data of the sample user for the target recommendation object; and the sample question answering data combination is constructed by using the sample question data as an input question of the intelligent question answering model, and using the sample recommendation reason as an output answer of the intelligent question answering model. The sample question answering data combination is constructed according to the historical behavior data of the user, so that training data may be easily obtained, and personalized performance requirements may be further met.

In addition, in the embodiments of the present disclosure, an initial recommendation reason of each recalled result may be obtained by using the intelligent question answering model according to the search data and the target user profile of the target user, and the initial recommendation reason is corrected according to the knowledge graph, to obtain a final recommendation reason of each recalled result. Preprocessing is performed on the initial recommendation reason, the preprocessing including at least one of named entity recognition (NER), syntactic parsing, and dependency parsing; and a preprocessed initial recommendation reason is corrected according to the knowledge graph, to obtain the final recommendation reason of each recalled result. A replaceable field in the preprocessed initial recommendation reason may be obtained based on a preset classification model, and then the replaceable field is corrected, to obtain the final recommendation reason of each recalled result, where the classification model is a second machine learning model obtained through training based on the knowledge graph. Therefore, the validity of the recommendation reason, and the correction efficiency and accuracy of the recommendation reason may be further improved.

In addition, in the embodiments of the present disclosure, the intelligent question answering model includes a seq2seq framework model combining an attention mechanism, and the attention mechanism includes a coverage attention mechanism, thereby avoiding a problem of “over translation” of the model. A prediction manner of the intelligent question answering model includes a beam search manner, to ensure the smoothness of a sentence to the greatest extent. A decoding layer of the seq2seq framework determines, through a context gate and when an input of the decoding layer in a current decoding step is obtained, a weight of an output of the decoding layer in a previous decoding step for the input in the current decoding step, thereby optimizing the information points and smoothness of the sentence.

An apparatus embodiment is basically similar to the method embodiment, and therefore is briefly described. For related parts, refer to partial descriptions of the method embodiment.

In the embodiments of the present disclosure, an electronic device is further provided, including a memory, a processor, and a computer program stored on the memory and executable on the processor, where the processor, when executing the computer program, implementing any one of the foregoing recommendation reason generation methods.

In the embodiments of the present disclosure, a computer-readable storage medium is further provided, storing a computer program, where the program, when executed by a processor, causing the processor to implement steps of any one of the foregoing recommendation reason generation methods.

The foregoing described apparatus embodiments are merely examples. The units described as separate parts may or may not be physically separate, and the parts displayed as units may or may not be physical units, may be located in one position, or may be distributed on a plurality of network units. Some or all of the modules may be selected according to actual requirements to achieve the objectives of the solutions of the embodiments. A person of ordinary skill in the art may understand and implement the solutions without creative efforts.

The various component embodiments of the present disclosure may be implemented in hardware or in software modules running on one or more processors or in a combination thereof. A person skilled in the art should understand that a microprocessor or a digital signal processor (DSP) may be used in practice to implement some or all of the functions of some or all of the components of the electronic device according to the embodiments of the present disclosure. The present disclosure may alternatively be implemented as a device or apparatus program (for example, a computer program and a computer program product) for performing part or all of the methods described herein. Such a program implementing the present disclosure may be stored on a computer-readable medium or may have the form of one or more signals. Such signals may be downloaded from Internet websites, provided on carrier signals, or provided in any other form.

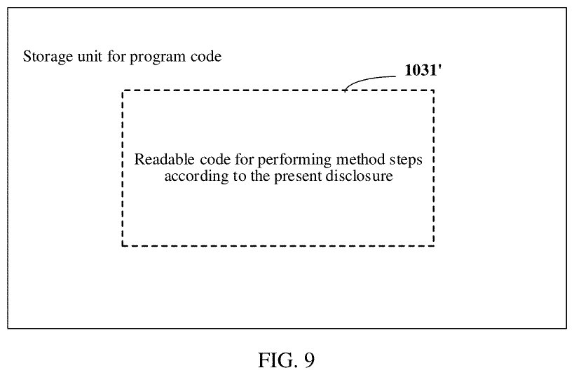

For example, FIG. 8 shows an electronic device that may implement the method according to the present disclosure. Conventionally, the electronic device includes a processor 1010 and a computer program product or a computer-readable storage medium in a form of a memory 1020. The memory 1020 may be an electronic memory such as a flash memory, an electrically erasable programmable read-only memory (EEPROM), an EPROM, a hard disk or a ROM. The memory 1020 has a storage space 1030 of program code 1031 used for performing any method step in the foregoing method. For example, the storage space 1030 for program code may include pieces of the program code 1031 used for implementing various steps in the foregoing method. The program code may be read from one or more computer program products or be written to the one or more computer program products. The computer program products include a program code carrier such as a hard disk, a compact disc (CD), a storage card or a floppy disk. Such a computer program product is generally a portable or fixed storage unit with reference to FIG. 9. The storage unit may have storage segments, storage spaces that are arranged similarly to the memory 1020 in the electronic device of FIG. 8. The program code may be, for example, compressed in an appropriate form. Generally, the storage unit includes computer-readable code 1031′, that is, code that can be read by a processor such as 1010. The code, when executed by an electronic device, causes the electronic device to execute the steps of the method described above.

“An embodiment”, “embodiment”, or “one or more embodiments” mentioned in the specification means that particular features, structures, or characteristics described with reference to the embodiment or embodiments may be included in at least one embodiment of the present disclosure. In addition, it should be noted that the wording example “in an embodiment” herein does not necessarily indicate a same embodiment.

Numerous specific details are set forth in the specification provided herein. However, it can be understood that, the embodiments of the present disclosure may be practiced without these specific details. In some examples, known methods, structures, and technologies are not disclosed in detail, so as not to mix up understanding on the specification.

In the claims, any reference signs placed between parentheses shall not be construed as limiting the claims. The word “comprise” does not exclude the presence of elements or steps not listed in the claims. The word “a” or “an” preceding an element does not exclude the presence of a plurality of such elements. The present disclosure can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names.

Finally, it should be noted that the foregoing embodiments are merely intended for describing the technical solutions of the present disclosure, but not for limiting the present disclosure. Although the present disclosure is described in detail with reference to the foregoing embodiments, a person of ordinary skill in the art should understand that they may still make modifications to the technical solutions described in the foregoing embodiments or make equivalent replacements to some technical features thereof, and such modifications or replacements shall not cause the essence of the corresponding technical solutions to depart from the spirit and scope of the technical solutions of the embodiments of the present disclosure.

1. A recommendation reason generation method, comprising:
obtaining, according to search data of a target user, at least one recalled result for the search data; and
obtaining a recommendation reason of each recalled result by using a preset intelligent question answering model according to the search data, the at least one recalled result, and a target user profile of the target user, wherein
the intelligent question answering model is a first machine learning model obtained through training according to at least one sample question answering data combination, and the sample question answering data combination comprising: a sample user profile and historical comment data of at least one sample user, a recommendation object corresponding to the historical comment data, and historical search data of the sample user for the recommendation object.

2. The method according to claim 1, wherein before the step of obtaining a recommendation reason of each recalled result by using a preset intelligent question answering model according to the search data, the at least one recalled result, and a target user profile of the target user, the method further comprises:
constructing the sample question answering data combination according to the historical comment data and the sample user profile of the sample user, the recommendation object corresponding to the historical comment data, and the historical search data of the sample user for the recommendation object; and
training the intelligent question answering model according to the sample question answering data combination.

3. The method according to claim 2, wherein the step of constructing the sample question answering data combination according to the historical comment data and the sample user profile of the sample user, the recommendation object corresponding to the historical comment data, and the historical search data of the sample user for the recommendation object comprises:
obtaining a commented target recommendation object of the sample user according to historical behavior data of the sample user and a recommendation object corresponding to the historical behavior data;
obtaining a sample recommendation reason of the sample user for the target recommendation object according to historical comment data of the sample user for the target recommendation object;
obtaining sample question data of the sample user for the target recommendation object according to the sample user profile of the sample user, the target recommendation object, and historical search data corresponding to the historical comment data; and
constructing the sample question answering data combination by using the sample question data as an input question of the intelligent question answering model, and using the sample recommendation reason as an output answer of the intelligent question answering model.

4. The method according to claim 1, wherein the step of obtaining a recommendation reason of each recalled result by using a preset intelligent question answering model according to the search data, the at least one recalled result, and a target user profile of the target user comprises:
obtaining an initial recommendation reason of each recalled result by using the intelligent question answering model according to the search data and the target user profile of the target user; and
correcting the initial recommendation reason according to a knowledge graph, to obtain a final recommendation reason of each recalled result.

5. The method according to claim 4, wherein the step of correcting the initial recommendation reason according to a knowledge graph, to obtain a final recommendation reason of each recalled result comprises:
performing preprocessing on the initial recommendation reason, the preprocessing comprising at least one of named entity recognition (NER), syntactic parsing, and dependency parsing; and
correcting a preprocessed initial recommendation reason according to the knowledge graph, to obtain the final recommendation reason of each recalled result.

6. The method according to claim 5, wherein the step of correcting a preprocessed initial recommendation reason according to the knowledge graph, to obtain the final recommendation reason of each recalled result comprises:
obtaining a replaceable field in the preprocessed initial recommendation reason based on a preset classification model; and
correcting the replaceable field, to obtain the final recommendation reason of each recalled result, wherein
the classification model is a second machine learning model obtained through training based on the knowledge graph.

7. The method according to claim 1, wherein the intelligent question answering model comprises a seq2seq framework model combining an attention mechanism, the attention mechanism comprising a coverage attention mechanism, a prediction manner of the intelligent question answering model comprises a beam search manner, and a decoding layer of the seq2seq framework determines, through a context gate and when an input of the decoding layer in a current decoding step is obtained, a weight of an output of the decoding layer in a previous decoding step for the input in the current decoding step.

8. An electronic device, comprising:
a memory, a processor, and a computer program stored on the memory and executable on the processor, when executing the computer program, the processor performing the following operations:
obtaining, according to search data of a target user, at least one recalled result for the search data; and
obtaining a recommendation reason of each recalled result by using a preset intelligent question answering model according to the search data, the at least one recalled result, and a target user profile of the target user, wherein
the intelligent question answering model is a first machine learning model obtained through training according to at least one sample question answering data combination, and the sample question answering data combination comprising: a sample user profile and historical comment data of at least one sample user, a recommendation object corresponding to the historical comment data, and historical search data of the sample user for the recommendation object.

9. The electronic device according to claim 8, wherein before the step of obtaining a recommendation reason of each recalled result by using a preset intelligent question answering model according to the search data, the at least one recalled result, and a target user profile of the target user, the method further comprises:
constructing the sample question answering data combination according to the historical comment data and the sample user profile of the sample user, the recommendation object corresponding to the historical comment data, and the historical search data of the sample user for the recommendation object; and
training the intelligent question answering model according to the sample question answering data combination.

10. The electronic device according to claim 9, wherein the step of constructing the sample question answering data combination according to the historical comment data and the sample user profile of the sample user, the recommendation object corresponding to the historical comment data, and the historical search data of the sample user for the recommendation object comprises:
obtaining a commented target recommendation object of the sample user according to historical behavior data of the sample user and a recommendation object corresponding to the historical behavior data;
obtaining a sample recommendation reason of the sample user for the target recommendation object according to historical comment data of the sample user for the target recommendation object;
obtaining sample question data of the sample user for the target recommendation object according to the sample user profile of the sample user, the target recommendation object, and historical search data corresponding to the historical comment data; and
constructing the sample question answering data combination by using the sample question data as an input question of the intelligent question answering model, and using the sample recommendation reason as an output answer of the intelligent question answering model.

11. The electronic device according to claim 8, wherein the step of obtaining a recommendation reason of each recalled result by using a preset intelligent question answering model according to the search data, the at least one recalled result, and a target user profile of the target user comprises:
obtaining an initial recommendation reason of each recalled result by using the intelligent question answering model according to the search data and the target user profile of the target user; and
correcting the initial recommendation reason according to a knowledge graph, to obtain a final recommendation reason of each recalled result.

12. The electronic device according to claim 11, wherein the step of correcting the initial recommendation reason according to a knowledge graph, to obtain a final recommendation reason of each recalled result comprises:
performing preprocessing on the initial recommendation reason, the preprocessing comprising at least one of named entity recognition (NER), syntactic parsing, and dependency parsing; and
correcting a preprocessed initial recommendation reason according to the knowledge graph, to obtain the final recommendation reason of each recalled result.

13. The electronic device according to claim 12, wherein the step of correcting a preprocessed initial recommendation reason according to the knowledge graph, to obtain the final recommendation reason of each recalled result comprises:
obtaining a replaceable field in the preprocessed initial recommendation reason based on a preset classification model; and
correcting the replaceable field, to obtain the final recommendation reason of each recalled result, wherein
the classification model is a second machine learning model obtained through training based on the knowledge graph.

14. The electronic device according to claim 8, wherein the intelligent question answering model comprises a seq2seq framework model combining an attention mechanism, the attention mechanism comprising a coverage attention mechanism, a prediction manner of the intelligent question answering model comprises a beam search manner, and a decoding layer of the seq2seq framework determines, through a context gate and when an input of the decoding layer in a current decoding step is obtained, a weight of an output of the decoding layer in a previous decoding step for the input in the current decoding step.

15. A non-volatile readable storage medium, wherein instructions in the storage medium, when executed by a processor of an electronic device, causes the electronic device to perform the recommendation reason generation method according to claim 1.

16. A computer program, comprising computer-readable code, the computer-readable code, when run on an electronic device, causing the electronic device to perform the recommendation reason generation method according to claim 1.
